(19) United States
(12) Patent Application Publication
(10) Pub. No.: US 2008/0281803 A1
(43) Pub. Date: Nov. 13, 2008

(54) Method of Transmitting Content With Adaptation of Encoding Characteristics

(75) Inventor: Philippe Gentric, Fourqueux (FR)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: KONINKLIJKE PHILIPS ELECTRONIC, N.V., EINDHOVEN (NL)

(21) Appl. No.: 10/596,486

(22) PCT Filed: Dec. 14, 2004
(86) PCT No.: PCT/IB04/04139

§ 371 Date: Jun. 15, 2006

(30) Foreign Application Priority Data
Dec. 22, 2003 (EP) 03300278.3

(51) Int. Cl. G06F 7/06; G06F 7/00; G06F 17/30

(52) U.S. Cl. 707/5; 707/101; 707/E17.008; 707/E17.014

(57) ABSTRACT

The invention proposes a method of transmitting a multimedia content from a server to a client device upon request of the client device, said method allowing adaptation of the characteristics of the encoder used for encoding the multimedia content based on the network transmission rate and/or client preference or preferences. The method of the invention consists in encoding the content with various encoder characteristics, thereby providing several encoded multimedia contents, slicing the encoded multimedia contents, thereby providing a plurality of file-based contents, downloading the content file by file while switching from one encoded multimedia content to another so as to change the encoding characteristics, thereby adapting to the network transmission rate and/or client preferences.

### FIELD OF THE INVENTION

The present invention relates to a method of transmitting a multimedia content through a distribution network from a server to a client device. It also relates to a server, a client device, an encoding system comprising encoders for encoding a multimedia content, and a network system comprising an encoder system, a server, a distribution network and a client device.

The invention is generally applicable in the field of multimedia content transmission through the web.

### BACKGROUND OF THE INVENTION

International patent application WO03/098935 filed by Koninklijke Philips Electronics N.V. describes a method of adapting the quality of a stream supplied to a client device in an audio/video streaming application. The purpose is to adapt the quality of the stream so that the bandwidth required for transmitting the stream matches the available bandwidth. One solution to achieve this is to switch among a plurality of pre-encoded streams corresponding to various encoding bit rates.

A problem of this solution is that the only encoder parameter that is changed is the encoding bit rate. The reason is that the other encoder parameters, such as the image size, cannot be changed during the streaming session (the decoder at the client side would be unable to decode the stream if the other encoder parameters were changed). The consequence of being unable to adapt the other encoder parameters is that the range of variation of the encoding bit rate is limited (under a certain limit, the bit rate cannot be further decreased without adapting the other encoder parameters, for example, without reducing the size of the image).

It is one of the objects of the present invention to propose a solution for transmitting a multimedia content to a client device that does not have the above-mentioned drawback.

### SUMMARY OF THE INVENTION

A method according to the invention for transmitting a multimedia content to a client device is defined in claims 1 to 3. An encoding system according to the invention for encoding a multimedia content is defined in claim 4. A server according to the invention for transmitting a multimedia content to a client device is defined in claims 5 to 7. A client device according to the invention is defined in claims 8 to 10 and a network system according to the invention is defined in claim 11.

According to the invention, a multimedia content is encoded by using various encoder characteristics so as to produce a plurality of encoded multimedia contents. The encoded multimedia contents are transformed in file-based contents by slicing them in at least one set of slicing positions forming slices that can be decoded independently of each other. Each slice of an encoded multimedia content is enclosed in a file, thereby generating a plurality of groups of at least one set of files, each group being associated with different encoder characteristics.

Upon request of a multimedia content by a client device, the server downloads said multimedia content file by file. Selection of a file to be downloaded includes selection of a slice and selection of a group. Modification of the characteristics of the transmitted data is achieved by switching from one group associated with first encoder characteristics to another group associated with second encoder characteristics.

As the transmission of the multimedia content is based on file downloading, the encoder characteristics can involve encoder parameters other than the encoding bit rate, for example, the image size in addition to the encoding bit rate. In another example, encoders using different encoding formats are used so that switching from one group to another allows changing the encoding format as well (for example, as most codec formats have a preferred operating bit rate, it may be more interesting to use a first encoding format with a slower bit rate and a second encoding format with a higher bit rate).

The group to which the downloaded file shall belong can be selected either by the server or by the client device. It is based on an estimation of the current transmission rate of the distribution network and/or on a client preference relating to the encoder characteristics. For example, the client may choose the bit rate and/or the image size he wants to receive (for example, for reasons of cost, he may prefer a low quality and therefore choose a small image size and/or a small bit rate). The client may also change the client preference during transmission (for example, after having received part of the data, he may decide that the content is of high interest and that he wants to get a better quality).

With the invention, the slices can be decoded independently of each other, which means that the client does not need to receive a multimedia content from its beginning. He can start from any slice. The invention is therefore applicable to the transmission of any type of content including live content (that is, content that is available in real time at the server side such as live events, broadcast programs, etc.).

When the multimedia content is a live content, several sets of slicing positions are advantageously used to reduce the delay experienced by the client before receiving a first file. When several sets of slicing positions are used, a group of several sets of files is available for each encoded multimedia content.

With the invention, a sequence of at least one file is downloaded upon request by a client device. The files can be either sent one by one upon reception of a single client request or fetched one by one by the client device. In practice, it is not certain that all client browsers will support receiving several files in response to a single request. Therefore it will usually be preferred that the client device fetches the files one by one (that is, sends a fetching request for each file to be downloaded). The client devices can be designed to send fetching requests automatically. Advantageously, when the client devices are not designed to send fetching requests automatically, a document is sent by the server upon reception of an initial request from the client device, said document causing the client device to repetitively send a fetching request.

It is to be noted that file downloading is usually implemented on IP networks by using the HTTP protocol (HTTP stands for Hyper Text Transfer Protocol; it is defined in the IETF Request for Comments 2616). The HTTP protocol is the basis of the web and is therefore accepted by all firewalls, which is not the case for the UDP protocol generally used in streaming applications (UDP stands for User Datagram Protocol; it is defined in the IETF Request for Comments 0768). As a consequence, the solution proposed in the present invention has the great advantage over the prior art solution that any client device will be able to receive the requested content irrespectively of the characteristics of the firewall through which it connects to the distribution network.

### BRIEF DESCRIPTION OF THE DRAWINGS

These and other aspects of the invention will be further described below with reference to the following drawings:

FIG. 1 is a schematic representation of a first example of a network system according to the invention,

FIG. 2 is a schematic representation of a slicing scheme to be used for slicing an encoded multimedia content according to the invention,

FIG. 3 is a schematic representation of a group of a plurality of sets of files generated by using the slicing scheme depicted in FIG. 2,

FIG. 4 is a schematic representation of two overlapping files,

FIG. 5 is a schematic representation of a group of three sets of files,

FIG. 6 is a block diagram of a method according to the invention for transmitting a multimedia content,

FIGS. 7 and 8 are schematic representations of other examples of a network system according to the invention.

### DESCRIPTION OF EMBODIMENTS

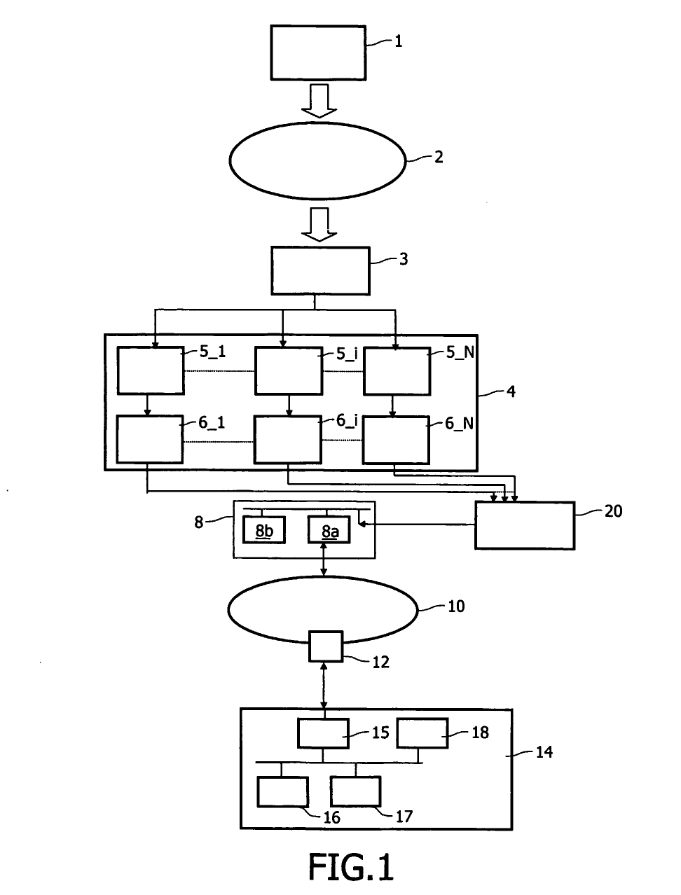

FIG. 1 is a schematic representation of a network system according to the invention. The network system of FIG. 1 comprises:

a source 1 for acquiring a multimedia content;

a broadcaster 2 for broadcasting said multimedia content;

a receiver 3 for receiving a broadcast multimedia content;

an encoding system 4 for encoding a received multimedia content and producing groups of at least one set of files,

a server 8 having access to said groups of files,

a distribution network 10, the server 8 being linked to the distribution network 10,

an access provider 12 for providing a client device 14 with an access to the distribution network 10.

The server 8 comprises a communication unit 8a and a processing unit 8b, said processing unit comprising a data memory, a program memory and a processor for executing instructions stored in the program memory.

The client device 14 comprises a communication unit 15 for transmission/reception to/from the access provider 12, a player 16 for playing an encoded multimedia content, a display 17 for displaying a multimedia content, and a processing unit 18 comprising a program memory, a data memory and a processor for executing instructions stored in the program memory. The client device 14 may be either a mobile device (like a mobile phone), in which case the communication unit 15 is a radio communication unit, or a wired device (like a PC), in which case the communication unit 15 is a wired communication unit. The distribution network 10 is typically the Internet network.

For instance, the broadcaster 2 is a satellite broadcasting network and the receiver 3 is a satellite receiver. This is not restrictive: any other broadcasting means could be used instead of satellite broadcasting means. The broadcast multimedia content may be any multimedia content that is transmitted and can be received by a number of receivers including the receiver 3. For instance, the broadcast multimedia content may be a television program, a pre-recorded event/program, a live event, etc.

The encoding system comprises:

a) N encoders 5_1 to 5_N having various characteristics for encoding the received multimedia content, thereby generating a plurality of encoded multimedia contents EC_1 to EC_N, and
b) N slicers 6_1 to 6_N for slicing said encoded multimedia contents in at least one set of slicing positions forming slices which can be decoded independently of each other, and for enclosing each slice of an encoded multimedia content in a file, thereby generating N groups G_1 to G_N of at least one set of files, each group being associated with an encoded multimedia content.

For instance, the encoders 5_1 to 5_N are compliant with one of the MPEG standards or with H263.

The encoders 5_1 to 5_N and the slicers 6_1 to 6_N are either implemented in a single device or in separate devices. In both cases, what is transmitted from an encoder 5_{—}i to a slicer 6_{—}i is an encoded stream (i is an integer comprised between 1 and N). Advantageously, the encoded stream is transmitted from an encoder 5_{—}i to a slicer 6_{—}i over IP by using the RTP protocol (RTP stands for Real-time Transport Protocol; it is defined in the IETF Request for Comments 1889). This is not restrictive. By way of example, the transport layer of the MPEG-2 standard, known as MPEG-2 TS, could be used as well.

The function of the slicers 6_1 to 6_N is to slice the encoded multimedia contents generated by the encoders 5_1 to 5_N in at least one set of slicing positions. The slicing positions define slices which comprise a given amount of time of an encoded multimedia content and can be decoded independently of each other. In practice, any encoded multimedia content generated by a multimedia encoder comprises so-called Random Access Points (RAP). In order to produce slices that can be decoded independently of each other, the slicing positions are chosen to be such that each slice starts with a Random Access Point. For instance, when the encoders are compliant with the MPEG-2 or MPEG-4 standard, the random access points are the I-frames of the MPEG-encoded multimedia contents, and the slicing positions are chosen in such a way that the first frame of each slice is an I-frame.

Advantageously, the size of the slices is adjustable. It may be identical for all slices or vary from one slice to another (for instance, the size of the slices may increase with time). The best efficiency is obtained with files that are relatively long because the more files are to be transported, the more overhead there is due to file headers.

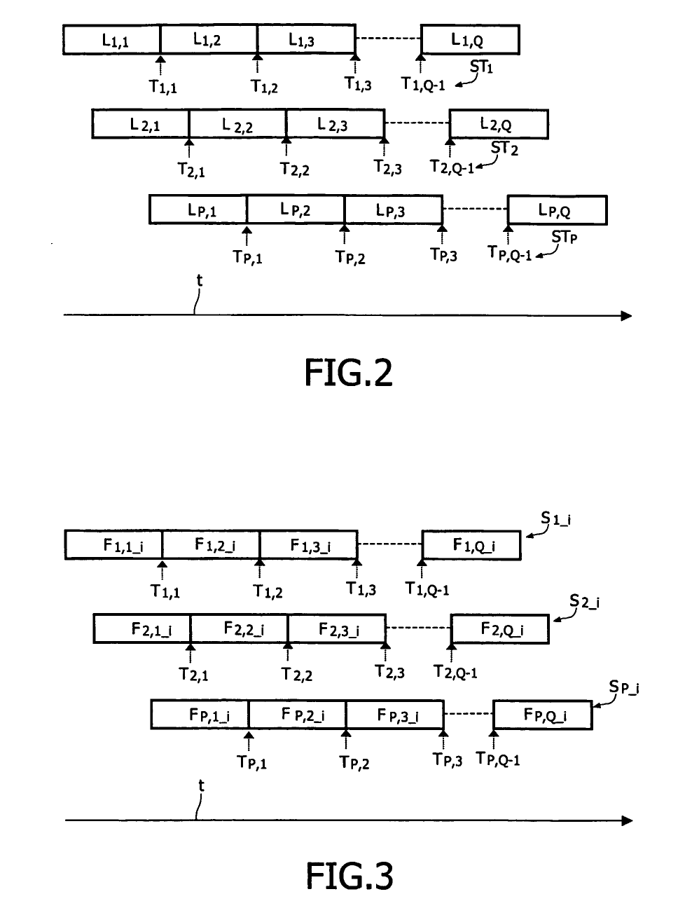

FIG. 2 is a schematic representation of a slicing scheme to be used for slicing the encoded multimedia contents EC_1 to EC_N. The slicing scheme represented in FIG. 2 comprises P sets of slicing positions ST₁, . . . , ST_{P}. Each set of slicing positions STₘ comprises Q−1 slicing positions T_{m,1}, . . . , T_{m,Q-1}. Each set of slicing positions is shifted in time compared with the other sets of slicing positions (the axis t is the time axis). With this slicing scheme, Q slices L_{m,1}, . . . , L_{m,Q} are formed for each set of slicing positions STₘ. As will be apparent from the description below, the use of a plurality of sets of slicing positions is advantageous when transmitting live multimedia content because it allows reducing the delay experienced by the client when he sends a request for a live content.

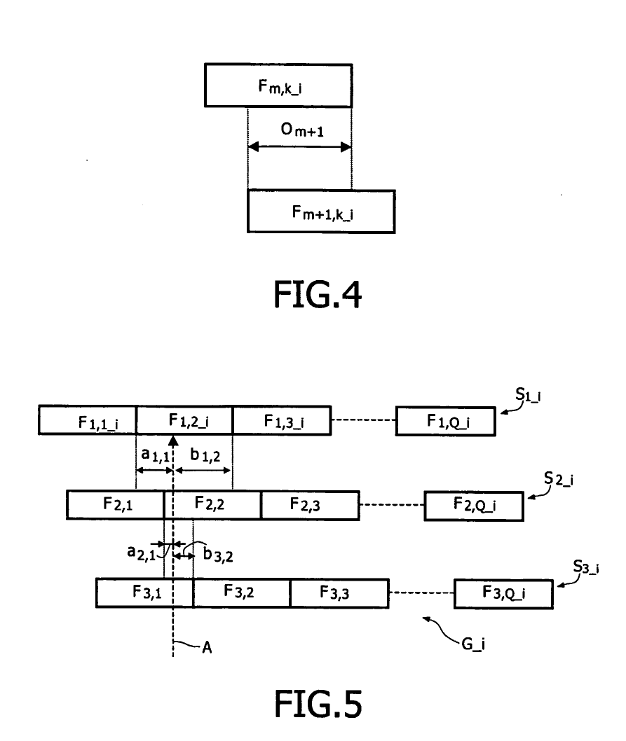

The slicers 6_1 to 6_N generate a plurality of groups of at least one set of files by slicing each encoded multimedia content in at least one set of slicing positions. FIG. 3 is a schematic representation of a group of files G_{—}i generated from an encoded multimedia content EC_{—}i by using the slicing scheme described in FIG. 2. As shown in FIG. 3, a group G_{—}i comprises P sets of files S₁_{_{—}}ᵢ, S₂_{_{—}}ᵢ, . . . , S_{P}_{_{—}}ᵢ. Each set of files Sₘ_{_{—}}ᵢ (m=1, . . . , P) comprises Q files F_{m,k}_{_{—}}ᵢ (m=1, . . . , P; k=1, . . . , Q). A set of slicing positions STₘ is associated with each set of files Sₘ_{_{—}}ᵢ. The files F_{m+1,k}_{_{—}}ᵢ and F_{m,k}_{_{—}}ᵢ are overlapping (they comprise identical encoded data). In FIG. 4, the overlap between the files F_{m+1,k}_{_{—}}ᵢ and F_{m,k}_{_{—}}ᵢ is indicated by an arrow Oₘ₊₁.

Each file generated by the slicers 6_1 to 6_N is stored in a storage unit 20 to which the server 8 has access. The storage unit 20 is shared by the slicers 6_1 to 6_N and the server 8. The storage unit 20 may be part of the server equipment or it may be at a remote location. The storage unit 20 has to be “cleaned” on a regular basis to ensure that there is room available for storing the newly generated files. A way of cleaning the storage unit is to re-use file names on a regular basis. An alternative way is to use different file names for each file, and to delete the aging files on a regular basis.

The server 8 is linked to the distribution network 10. The client device 14 has access to the distribution network 10 via the access provider 12. Typically, the client device 14 can load a page through the distribution network 10, which page contains at least one link to a multimedia content that the server 8 offers for transmission. When a user clicks on said link, an initial request R₀ directed to said multimedia content is automatically sent to the server 8. There are several possible ways for the server 8 to handle the initial request R₀.

In a first embodiment, the server 8 downloads a single file in response to the client request. This implementation can be used for specific applications, for instance, for applications offering the client to pick up information regarding a live event. It can also be used with a player 16 specifically designed to cause the client device 14 to send the initial request R₀ repetitively.

In a second embodiment, the server 8 downloads the files one by one as soon as they are ready at the server side. This embodiment has the advantage that it is easy to implement. However, there is a risk that certain client browsers will not support receiving several files in response to a single request.

In a third embodiment (usually preferred), the server 8 sends a document to the client device 14 upon reception of the initial request R₀. This document causes the client device 14 to repetitively send a fetching request designating the multimedia content.

By way of example, the document sent by the server 8 may be a page comprising an automatic refresh command. An example of such a page is given below:

<html>
<head>
<META meta http-equiv=“Refresh” content=“134” ;
url=‘http://www.yoursite.com/live2download.html’”
</head>
<embed src=“live2download.mp4” width=“240” height=“240”>
</embed>
</html>

Such a page causes the client browser to reload the file “live2download.mp4” every 134 seconds (which is the duration of a file in this example).

Alternatively, the document sent by the server 8 may be a standard description of the multimedia content, said standard description being intended to be processed by the player 16 in a standard way. For instance, such a description may be a SMIL description (SMIL is a W3C standard defining XML-based audio/video scene descriptions). An example of such a SMIL description is given below:

<smil>
<head>
<layout>
<root-layout width=“240” height=“240” background-color=“white”/>
<region regionName=“im” left=“0” top=“0” width=“240” height=“240”/>
</layout>
</head>
<body>
<seq repeatCount = “indefinite” >
<video id=“vid” src=“live2download.mp4” region=“im” />
</seq>
</body>
</smil>

The effect of this SMIL document is to cause the player 16 to play the file “live2download.mp4” repetitively. As a result, the client device will repetitively send fetching requests directed to the file “live2download.mp4”.

Advantageously, the SMIL document sent by the server 8 comprises a command indicating that the files have to be fetched some time in advance (that is, some time before the end of playback of the previous file). This ensures that the next file will arrive at the client device 14 on time so that the client will not experience a gap in the rendering of the multimedia content. An example of a SMIL description having such a command is given below:

<smil>
<head>
<layout>
<root-layout width=“240” height=“240” background-color=“white”/>
<region regionName=“im” left=“0” top=“0” width=“240” height=“240”/>
</layout>
</head>
<body>
<seq repeatCount = “indefinite” >
<video id=“vid” src=“live2download1.mp4” region=“im” clipBegin =
“0s” dur =
“25s” />
<par>
<prefetch src=“live2download2.mp4” mediaTime =“5s” />
<video id=“vid” src=“live2download1.mp4” region=“im” clipBegin =
“25s” />
</par>
<video id=“vid” src=“live2download2.mp4” region=“im” clipBegin =
“0s” dur =
“25s” />
<par>
<prefetch src=“live2download1.mp4” mediaTime =“5s” />
<video id=“vid” src=“live2download2.mp4” region=“im” clipBegin =
“25s” />
</par>
</seq>
</body>
</smil>

This document is written for slices containing 30 s of content. It causes the player to execute the following operations in sequence:

a) playing the first 25 s of a first source (live2download1.mp4);
b) playing the last 5 s of the first source and in parallel fetching the first 5 s of a second source (live2download2.mp4);
c) playing the first 25 s of the second source (which can be done without delay because the first 5 s have been pre-fetched).
Using two different sources is an implementation trick. The server 8 must be designed to recognize that the first and the second source correspond to the same multimedia content. In the three embodiments described above, the server has to determine which file should be downloaded upon reception of the initial request R₀ or upon reception of the fetching requests. According to the present invention, the file to be downloaded is determined by selecting a slice and by selecting a group of files (selection of the slice L_{m,k} and of the group G_{—}i leads to downloading of file F_{m,k}_{_{—}}ᵢ).

Advantageously, the group is selected by taking into account the current transmission rate of the distribution network 10 and/or client preferences relating to the encoder characteristics (said client preferences may change with time). Switching from one group associated with first encoder characteristics to another group associated with second encoder characteristics allows adaptation to the current transmission rate of the distribution network 10 and/or to client preferences received from the client device.

In a first alternative, the group is selected at the server side on the basis of information transmitted by the client device. The transmitted information comprises either the current transmission rate of the distribution network 10 or traffic information used by the server 8 to calculate the current transmission rate of the distribution network 10. Alternatively or in addition, the transmitted information may comprise a client preference like a desired bit rate and/or an image size and/or codec.

In a second alternative, the group is selected by the client device 14 and an indication of the selected group is sent to the server 8.

Information and/or indications transmitted from the client device 14 to the server 8 are transmitted, for example, in the initial and/or fetching request or requests. Alternatively, they are transmitted in a separate control channel established between the client device 14 and the server 8. Alternatively, the selected group can be indicated to the server 8 by using a specific naming convention when designating the multimedia content to be transmitted (in this case, the name of the multimedia content to be transmitted indicates which group is to be used).

For example, when the transport protocol is HTTP, it is possible to register specific parameters at the Internet Assigned Numbers Authority (IANA) to be used for transmitting the above-mentioned information and/or indications.

The slice is selected by the server 8 so as to ensure continuity in the transmitted multimedia content (in other words, when the previous selected slice was L_{x,k}(x ε{1, . . . , P}), the next selected slice shall be L_{y,k+1} (yε{1, . . . , P}). When several sets of slicing positions are used (P>1), upon reception of an initial request directed to a live content, the server 8 can either select the most recent slice or the closest future slice compared to the time of arrival of the initial request. The consequence of selecting the most recent slice is that the client will receive outdated data. The consequence of selecting the closest future slice is that the client will have to wait a certain time before getting a response. In both cases, the inconvenience for the client is reduced when several sets of files are used. This is illustrated in FIG. 5.

FIG. 5 shows a group G_{—}i of three sets of files S₁_{_{—}}ᵢ, S₂_{_{—}}ᵢ and S₃_{_{—}}ᵢ. An arrow A indicates the reception of a request by the server 8.

When the only set to be generated by the slicer 6_{—}i is the first set S₁_{_{—}}ᵢ, the server 8 will either download the file F_{1,1}_{_{—}}ᵢ (the most recent file) or the file F_{1,2}_{_{—}}ᵢ (the closest future file). If the server 8 downloads the file F_{1,1}_{_{—}}ᵢ, the data received by the client will be late by a time which is equal to a_{1,1}. If the server downloads the file F_{1,2}_{_{—}}ᵢ, the client will experience a delay which is equal to b_{1,2} before receiving the data.

When the three sets S₁_{_{—}}ᵢ, S₂_{_{—}}ᵢ and S₃_{_{—}}ᵢ are generated by the slicer 6, the server 8 will either download the file F_{2,1}_{_{—}}ᵢ (the most recent file) or the file F_{3,2}_{_{—}}ᵢ (the closest future file). If the server 8 downloads the file F_{2,1}_{_{—}}ᵢ, the data received by the client will be late by a time which is equal to a_{2,1}. If the server downloads the file F_{3,2}_{_{—}}ᵢ, the client will experience a delay which is equal to b_{3,2} before receiving the data. It can be seen that a_{1,1}>a_{2,1} and b_{1,2}>b_{3,2}.

HTTP is a stateless protocol and therefore HTTP requests issued by the same client device are normally processed independently of each other. As a result, when the transmissions over the distribution network 10 are ruled by the HTTP protocol, there is a risk that playback of the content cannot be achieved smoothly (some parts of the content may be received several times, or some parts of the content may be missing). A fourth embodiment solving this problem will now be described.

In the fourth embodiment, the document sent by the server 8 in response to the initial request R₀ comprises a resource identifier designating the multimedia content asked by the client. This resource identifier is specific to the client device 14. The document sent by the server 8 causes the client device 14 to repetitively send a fetching request containing this resource identifier. Upon reception of the first fetching request, the server 8 determines the file to be downloaded as described above (slice selection by the server, and group selection by either the server or the client device). The server 8 downloads the file and keeps a record of the slice that was downloaded. Upon reception of subsequent fetching requests containing the same resource identifier, the server 8 checks the record to select the next slice to be used, downloads the appropriate file and updates the record.

In this way, each client device 14 will receive a sequence of files that is complete and correctly ordered (all the received files are consecutive files belonging to the same set of files).

By way of example, the resource identifier comprised in the document sent by the server 8 may be a “nonce” as defined in the RFC1510 of the IETF (a nonce is a number that is used only once). An example of a SMIL document comprising such a resource identifier is given below:

<smil>
<head>
<layout>
<root-layout width=“240” height=“240” background-color=“white”/>
<region regionName=“im” left=“0” top=“0” width=“240” height=“240”/>
</layout>
</head>
<body>
<seq repeatCount = “indefinite” >
<video id=“vid” src=“cnn142299293873635534291919.mp4”
region=“im” />
</seq>
</body>
</smil>

Here, the resource identifier is cnn142299293873635534291919. The client device 14 will repetitively send fetching requests for the file cnn142299293873635534291919.mp4. The server 8 will keep track of which file was downloaded (or is to be downloaded) for the resource identifier cnn142299293873635534291919.

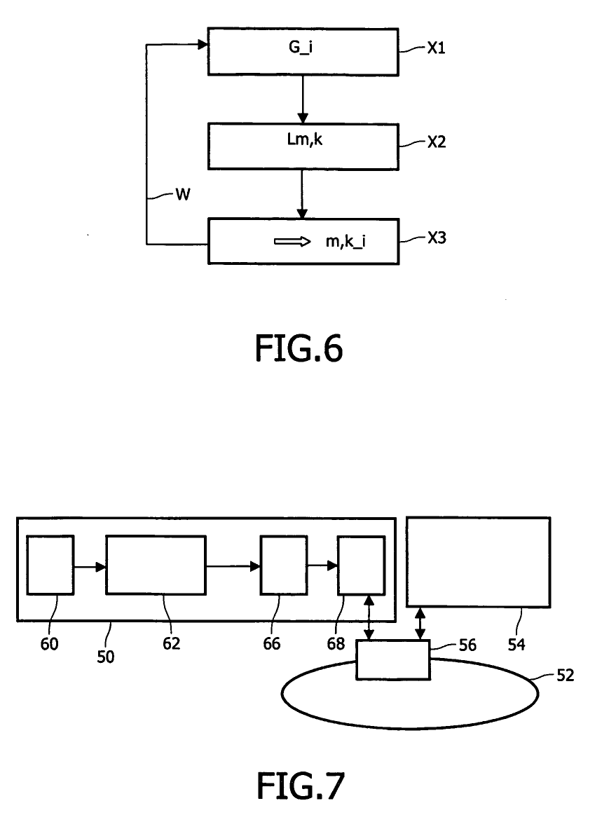

The steps that have been discussed above are summarized in FIG. 6. As shown in FIG. 56, a method according to the invention for transmitting a multimedia content comprises:

a step X1 of selecting a group G_{—}i from said plurality of groups (i=1, . . . , N),

a step X2 of selecting a slice S_{m,k} (m=1, . . . , P and k=1, . . . , Q), and

a step of downloading, from said server to said client device, the file F_{m,k}_{_{—}}ᵢ that contains the selected slice and belongs to the selected group.

An arrow W indicates that the steps X1 to X3 are executed several times for the transmission of a sequence of files.

Step X1 is executed by either the client device 14 or the server 8. Steps X2 and X3 are executed by the server 8.

These steps are implemented by way of specific hardware and/or software comprised in the server 8 and/or in the client device 14.

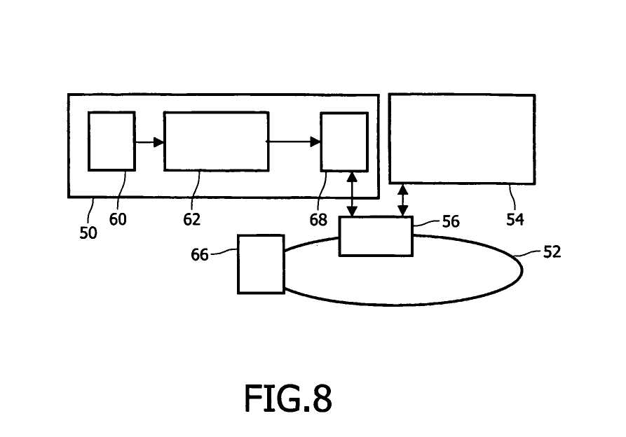

Two other examples of a network system according to the invention will now be described with reference to FIGS. 7 and 8.

The network system of FIG. 7 comprises a first client device 50, a distribution network 52, a second client device 54, and at least one access provider 56 for providing the first and the second client devices 50 and 54 with an access to the distribution network 52.

The second client device 54 is similar to the client device 14 described with reference to FIG. 1. Typically, the distribution network 52 is the Internet network.

The first client device 50 comprises:

a source 60 for acquiring a multimedia content,

an encoding system 62 for encoding an acquired multimedia content with various encoder characteristics and for slicing the encoded multimedia contents,

a server 66 having access to the files generated by the encoding system 62,

a communication unit 68 for transmission/reception to/from the access provider 56.

Typically, the first client device is a mobile phone, which means that the communication unit 68 is a radio communication unit.

The functionalities of the source 60, the encoding system 62 and the server 66 are identical to the functionalities of the source 1, the encoding system 4 and the server 8 described above with reference to FIGS. 1 to 6.

FIG. 8 is a schematic representation of an alternative solution, in which the server 66 is located in the distribution network 52 instead of being located in the first client device 50. In this embodiment, the first client device 50 will upload the files generated by the encoding system 62 to the server 66, and the server 66 will in turn download the file or files to the second client device 54.

Typically, the first client 50 sends a link towards a multimedia content (for instance, a video that is being captured by the first client device 50) to the second client device 54, for instance, via SMS (Short Message Service). When the second client clicks on the link contained in the SMS, an initial request directed to the multimedia content is sent to the first client device 50. Upon reception of this initial request, the first client device 50 operates as described above with reference to FIGS. 1 to 5.

With respect to the described network system, server, encoding system, client device and transmitting method, modifications or improvements may be proposed without departing from the scope of the invention. The invention is thus not limited to the examples described hereinbefore.

In particular the “progressive downloading” concept disclosed in European patent application no 03290453.4 filed on May 7, 2003 by Koninklijke Philips Electronics N.V. can be combined with the present invention. When a file generated by a slicer 6_{—}i is progressively downloaded, the player 16 does not need to wait until the file is completely downloaded to start playing the file.

Use of the verb “comprise” and its conjugations in the description and claims do not exclude the presence of elements other than those stated in the description and claims. Use of the article “a” or “an” for designating an element does not exclude the presence of a plurality of such elements.

1. A method of transmitting a multimedia content from a server to a client device through a distribution network upon request of said client device,
said method using a plurality of groups of at least one set of files, each group being associated with an encoded multimedia content, said encoded multimedia contents being obtained by encoding said multimedia content with various encoder characteristics, said groups being obtained by slicing said encoded multimedia contents in at least one set of slicing positions forming slices that can be decoded independently of each other, each file containing a slice of an encoded multimedia content, said method comprising:
a step of selecting a group from said plurality of groups,
a step of selecting a slice, and
a step of downloading, from said server to said client device, the file that contains the selected slice and belongs to the selected group,
said steps being executed at least once.

2. A method as claimed in claim 1, further comprising a step of calculating an estimation of the current transmission rate of the distribution network, wherein said group selection step takes said estimation into account.

3. A method as claimed in claim 1, further comprising a step of transmitting a client preference relating to said encoder characteristics from said client device to said server, and wherein said group selection step takes said client preference into account.

4. An encoding system comprising
a plurality of encoders with various encoder characteristics for encoding a multimedia content, thereby generating a plurality of encoded multimedia contents, and
a plurality of slicers for slicing said encoded multimedia contents in at least one set of slicing positions forming slices that can be decoded independently of each other, and for enclosing each slice of an encoded multimedia content in a file, thereby generating a plurality of groups of at least one set of files, each group being associated with an encoded multimedia content.

5. A server having access to a plurality of groups of at least one set of files, each group being associated with an encoded multimedia content, said encoded multimedia contents being obtained by encoding a multimedia content with various encoder characteristics, said groups being obtained by slicing said encoded multimedia contents in at least one set of slicing positions forming slices that can be decoded independently of each other, each file containing a slice of an encoded multimedia content, said server comprising:
means for selecting a slice,
means for downloading the file that contains the selected slice and belongs to a selected group,
said means being activated at least once upon reception of a request directed to said multimedia content from said client device.

6. A server as claimed in claim 5, further comprising means for receiving information relating to the current transmission rate of the distribution network from said client device, and group selection means for selecting said group on the basis of said information.

7. A server as claimed in claim 5, further comprising means for receiving client preference data, and group selection means for selecting said group on the basis of said client preference data.

8. A client device comprising:
means for connecting to a server through a distribution network,
means for selecting a group of at least one set of files from a plurality of groups, each group being associated with an encoded multimedia content, said encoded multimedia contents being obtained by encoding a multimedia content with various encoder characteristics, said groups being obtained by slicing said encoded multimedia contents in at least one set of slicing positions forming slices that can be decoded independently of each other, each file containing a slice of an encoded multimedia content,
means for sending at least one request to said server, said request being directed to said multimedia content and comprising an indication of the selected group.

9. A client device as claimed in claim 8, further comprising means for calculating an estimation of the current transmission rate of said distribution network, and wherein said group selection means take said estimation into account.

10. A client device as claimed in claim 8, further comprising means for getting a client preference, and wherein said group selection means take said client preference into account.

11. A network system comprising:
a plurality of encoders with various encoder characteristics for encoding a multimedia content, thereby generating a plurality of encoded multimedia contents,
a plurality of slicers for slicing said encoded multimedia contents in at least one set of slicing positions forming slices that can be decoded independently of each other, and for enclosing each slice of an encoded multimedia content in a file, thereby generating a plurality of groups of at least one set of files, each group being associated with an encoded multimedia content,
a distribution network,
a client device having means for connecting to a server through said distribution network, and means for sending at least one request to said server, said request being directed to said multimedia content, and
a server having access to said plurality of groups, said server comprising:
a) means for selecting a slice,
b) means for downloading the file that contains the selected slice and belongs to a selected group,
said means being activated at least once upon reception of a request directed to said multimedia content from said client device.
